(19) United States
(12) Patent Application Publication
(10) Pub. No.: US 2025/0308746 A1
(43) Pub. Date: Oct. 2, 2025

(54) MAGNETIC COMPONENT

(71) Applicant: LITE-ON TECHNOLOGY CORPORATION, Taipei (TW)

(72) Inventors: Bo-Ruei CIOU, Taipei (TW); Yen-An Chen, Taipei (TW); Chen Chen, Taipei (TW)

(21) Appl. No.: 18/884,165

(22) Filed: Sep. 13, 2024

Related U.S. Application Data
(60) Provisional application No. 63/570,872, filed on Mar. 28, 2024.

(30) Foreign Application Priority Data
Jul. 5, 2024 (CN) 202421586624.1

(51) Int. Cl. H01F 27/02; H01F 19/00; H01F 27/245

(52) U.S. Cl. CPC H01F 27/025; H01F 27/245; H01F 19/00

(57) ABSTRACT

A magnetic component is provided. The magnetic component comprises a magnetic core, a first winding and a second winding. The magnetic core includes an upper cover body and a lower cover body that are stacked. The lower cover body has a first winding column and a second winding column. The first winding is wound on the first winding column. The second winding is wound on the second winding column. The first winding column and the second winding column are spaced apart along a length direction of the magnetic component. The first winding column and the second winding column are configured deviated from each other along a width direction of the magnetic component perpendicular to the length direction.

This application claims the benefits of the U.S. provisional application Ser. No. 63/570,872 filed Mar. 28, 2024 and the PRC application Serial No. 202421586624.1 filed Jul. 5, 2024, the disclosure of which are incorporated by reference herein in their entirety.

### TECHNICAL FIELD

The present invention relates to a magnetic component, and in particular relates to a magnetic component for an integrated transformer.

### BACKGROUND

In the structure of a conventional integrated transformer, a first winding is wound around a first winding column of a magnetic core to form one transformer unit, a second winding is wound around a second winding column of the magnetic core to form another transformer unit, and then these two independent transformer units are arranged horizontally in series along a single direction, thereby forming an integrated transformer. However, this kind of conventional integrated transformer has the following problems: that in a situation with a preset cooling airflow direction, a magnetic core of one transformer unit on one side will block the airflow blowing towards a magnetic core of the other transformer unit on another side because of the horizontal arrangement, thereby causing an uneven internal heat dissipation of the integrated transformer.

### SUMMARY

The present invention relates to a magnetic component, each winding and corresponding winding column of which can be passed by airflow by a deviation arrangement between a plurality of winding columns in a situation with a preset cooling airflow direction, thereby solving the problem about the uneven internal heat dissipation.

According to an aspect of the present invention, a magnetic component is provided. The magnetic component comprises a magnetic core, a first winding and a second winding. The magnetic core includes an upper cover body and a lower cover body that are stacked. The lower cover body has a first winding column and a second winding column. The first winding is wound on the first winding column. The second winding is wound on the second winding column. The first winding column and the second winding column are spaced apart along a length direction of the magnetic component. The first winding column and the second winding column are configured deviated from each other along a width direction of the magnetic component perpendicular to the length direction.

The above summary is not intended to represent all embodiments or all aspects of the present invention. Rather, the foregoing summary merely provides examples that illustrate the novel aspects and features of the present invention. The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

The following figures are merely illustrative of embodiments and are not intended to limit the scope of embodiments or claims.

FIG. 1A and FIG. 1C are three dimensional views of a magnetic component according to the first embodiment of the present invention.

FIG. 1B is a top view of the magnetic component in FIG. 1A.

FIG. 1D is a side view of the magnetic component in FIG. 1C.

FIG. 2A and FIG. 2C are three dimensional views of a magnetic component according to the second embodiment of the present invention.

FIG. 2B is a top view of the magnetic component in FIG. 2A.

FIG. 2D is a side view of the magnetic component in FIG. 2C.

FIG. 3A and FIG. 3C are three dimensional views of a magnetic component according to the third embodiment of the present invention.

FIG. 3B is a top view of the magnetic component in FIG. 3A.

FIG. 3D is a side view of the magnetic component in FIG. 3C.

FIG. 4A and FIG. 4C are three dimensional views of a magnetic component according to the fourth embodiment of the present invention.

FIG. 4B is a top view of the magnetic component in FIG. 4A.

FIG. 4D is a side view of the magnetic component in FIG. 4C.

### DETAILED DESCRIPTION

Detailed descriptions of the embodiments of the specification are disclosed below with reference to the accompanying drawing. Apart from the said detailed descriptions, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar sign.

The first embodiment is described as follows:

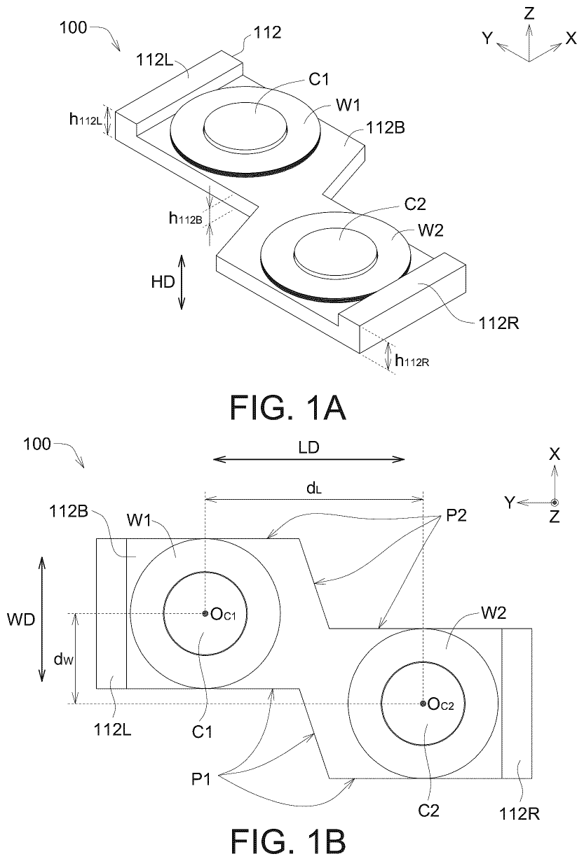

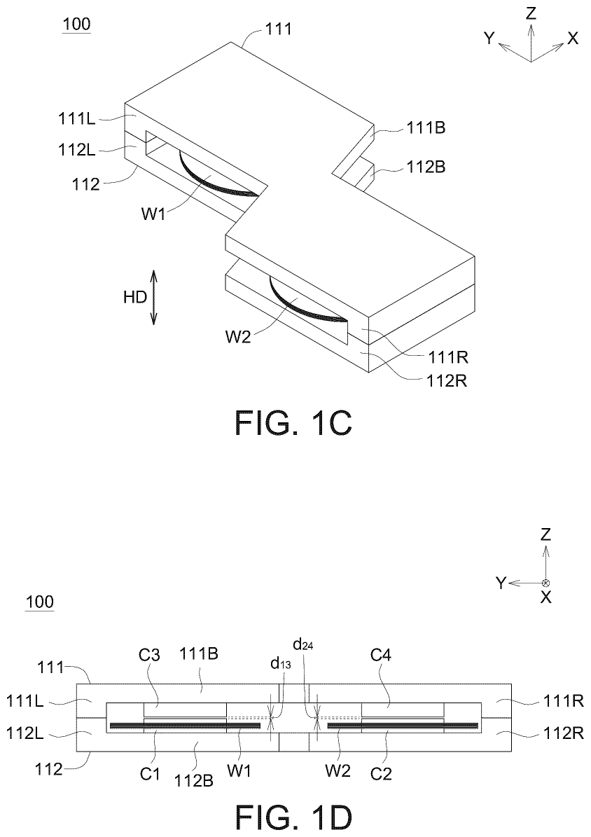

Please refer to FIG. 1A to FIG. 1D, which illustrate a magnetic component 100 of the first embodiment of the present invention. FIG. 1A and FIG. 1C show three dimensional views of the magnetic component 100. FIG. 1B shows a top view corresponding to FIG. 1A. FIG. 1D shows a top view corresponding to FIG. 1C. In order to clearly show an internal arrangement of the magnetic component 100, an upper cover body 111 of the magnetic core of the magnetic component 100 is not shown in FIG. 1A and FIG. 1B.

The magnetic component 100 of this embodiment is, for example, a transformer, a ferrite core inductor or a combination thereof. The magnetic component 100 comprises a magnetic core, a first winding W1 and a second winding W2. The magnetic core includes an upper cover body 111 and a lower cover body 112. The lower cover body 112 has a first winding column C1 and a second winding column C2. The first winding W1 is wound around the first winding column C1, and the second winding W2 is wound around the second winding column C2. The first winding W1 and the second winding W2 may respectively be a primary coil and a secondary coil. The number of the primary coil and the secondary coil depends on the actual application requirement, and the present invention is not limited thereto. The shape of the first winding column C1 and the second winding column C2 is, for example, cylinder, but the present invention is not limited thereto. The shape of the first winding column C1 and the second winding column C2 may both be prisms. Alternatively, the shape of the first winding column C1 and the second winding column C2 may also be different, for example, one is a cylinder, and the other is a prism.

As shown in FIG. 1B, the first winding column C1 and the second winding column C2 are spaced apart along a length direction LD of the magnetic component 100, and the first winding column C1 and the second winding column C2 are configured deviated from each other along a width direction WD of the magnetic component 100. The width direction WD (parallel to X-axis in drawings) is perpendicular to the length direction LD (parallel to Y-axis in drawings). Specifically, there is a distance di between a center O_{C1} of the first winding column C1 and a center O_{C2} of the second winding column C2 in the length direction LD, and there is a distance d_{W} between the center O_{C1} of the first winding column C1 and the center O_{C2} of the second winding column C2 in the width direction WD. That is, the first winding column C1 and the second winding column C2 are diagonally arranged in the magnetic component 100, rendering the present invention different from the horizontal arrangement of the prior art. Therefore, in a situation with a preset cooling airflow direction along the length direction LD, the second winding W2, the first winding column C1 and the second winding column C2 of the magnetic component 100 can be all passed by airflow by this diagonal configuration, thereby solving the problem about the uneven internal heat dissipation.

Further, the lower cover body 112 has a base 112B and two side columns. The first winding column C1 and the second winding column C2 are formed on the base 112B. In this embodiment, the two side columns are a left column 112L and a right column 112R. The left column 112L and the right column 112R are formed at two ends of the base 112B. The first winding column C1 and the second winding column C2 are located between the left column 112L and the right column 112R. The first winding column C1 is adjacent to the left column 112L, and the second winding column C2 is adjacent to the right column 112R. Corresponding to the diagonal arrangement of the first winding column C1 and the second winding column C2 in the magnetic component 100, the left column 112L and the right column 112R are also deviated from each other along the width direction WD. As shown in FIG. 1A, in a height direction HD of the magnetic component 100, a height h_{112L} of the left column 112L is equal to a height h_{112R} of the right column 112R, and the heights of these two side columns are greater than a height h_{112B} of the base 112B. The height direction HD (parallel to Z-axis in drawings) is perpendicular to the length direction LD and the width direction WD.

As shown in FIG. 1B, a projection of the first winding column C1 in the length direction LD fully overlaps the left column 112L, and a projection of the second winding column C2 in the length direction LD fully overlaps the right column 112R. Further, the base 112B has two opposite polyline side walls. In this embodiment, the two polyline side walls are respectively the front polyline side wall P1 and the rear polyline side wall P2. The front polyline side wall P1 and the rear polyline side wall P2 are connected between the left column 112L and the right column 112R. The front polyline side wall P1 and the rear polyline side wall P2 are each a polygonal wall structure. This polyline line structure design is to correspond to the diagonal arrangement of the first winding column C1 and the second winding column C2 of the magnetic component 100, and it can reduce a floor space of the base 112B.

As shown in FIG. 1C, corresponding to the structure of the lower cover body 112, the upper cover body 111 also has the same designed base 111B, left column 111L and right column 111R. The left column 111L of the upper cover body 111 abuts against the left column 112L of the lower cover body 112, and the right column 111R of the upper cover body 111 abuts against the right column 112R of the lower cover body 112, so that the upper cover body 111 and the lower cover body 112 can be stacked. As shown in FIG. 1D, corresponding to the structure of the lower cover body 112, the upper cover body 111 also has a third winding column C3 and a fourth winding column C4. Similar to the design of the lower cover body 112, the third winding column C3 and the fourth winding column C4 are spaced apart along the length direction LD, and the third winding column C3 and the fourth winding column C4 are configured deviated from each other along the width direction WD. As such, the first winding column C1 of the lower cover body 112 can be aligned with the third winding column C3 of the upper cover body 111, and the second winding column C2 of the lower cover body 112 can be aligned with the fourth winding column C4 of the upper cover body 111. In this embodiment, when the upper cover body 111 and the lower cover body 112 are stacked, there is a gap d₁₃ between the first winding column C1 and the third winding column C3, and there is a gap d₂₄ between the second winding column C2 and the fourth winding column C4, but the present invention is not limited thereto. Alternatively, the first winding column C1 may also be in contact with the third winding column C3, and the second winding column C2 may also be in contact with the fourth winding column C4.

The second embodiment is described as follows:

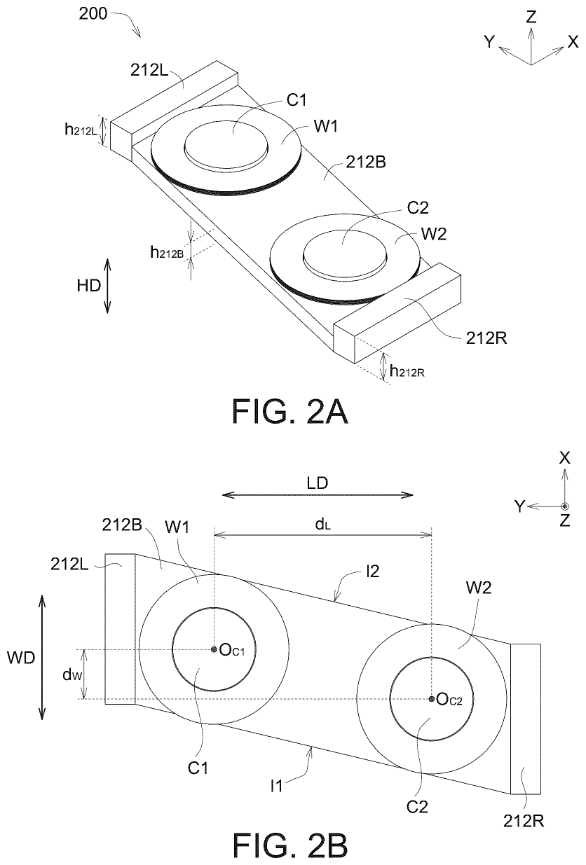

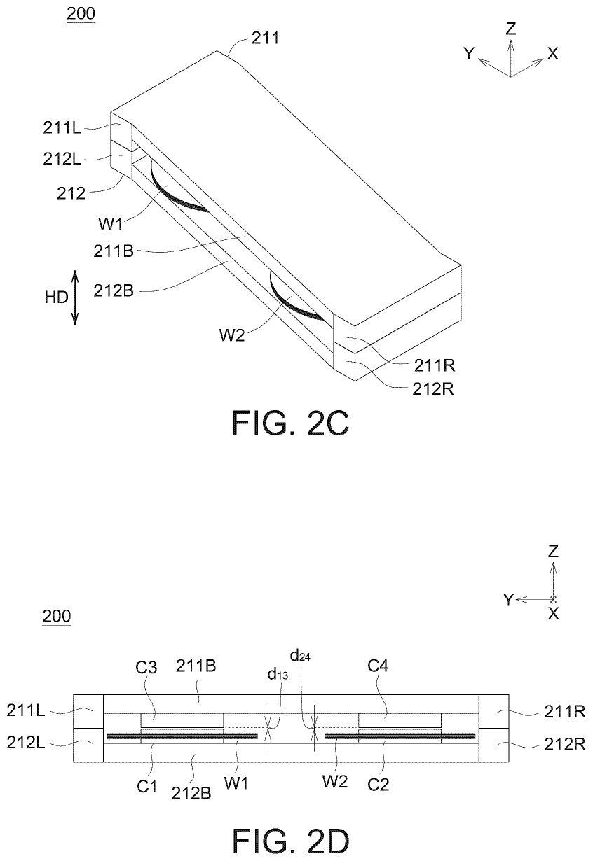

Please refer to FIG. 2A to FIG. 2D, which illustrate a magnetic component 200 of the first embodiment of the present invention. FIG. 2A and FIG. 2C show three dimensional views of the magnetic component 200. FIG. 2B shows a top view corresponding to FIG. 2A. FIG. 2D shows a top view corresponding to FIG. 2C. In order to clearly show an internal arrangement of the magnetic component 200, an upper cover body 211 of the magnetic core of the magnetic component 200 is not shown in FIG. 2A and FIG. 2B.

The magnetic component 200 of this embodiment is, for example, a transformer, a ferrite core inductor or a combination thereof. The magnetic component 200 comprises a magnetic core, a first winding W1 and a second winding W2. The magnetic core includes an upper cover body 211 and a lower cover body 212. The lower cover body 212 has a first winding column C1 and a second winding column C2. The first winding W1 is wound around the first winding column C1, and the second winding W2 is wound around the second winding column C2. The first winding W1 and the second winding W2 may respectively be a primary coil and a secondary coil. The number of the primary coil and the secondary coil depends on the actual application requirement, and the present invention is not limited thereto. The shape of the first winding column C1 and the second winding column C2 is, for example, cylinder, but the present invention is not limited thereto. The shape of the first winding column C1 and the second winding column C2 may both be prisms. Alternatively, the shape of the first winding column C1 and the second winding column C2 may also be different, for example, one is a cylinder, and the other is a prism.

As shown in FIG. 2B, the first winding column C1 and the second winding column C2 are spaced apart along a length direction LD of the magnetic component 200, and the first winding column C1 and the second winding column C2 are configured deviated from each other along a width direction WD of the magnetic component 200. The width direction WD (parallel to X-axis in drawings) is perpendicular to the length direction LD (parallel to Y-axis in drawings). Specifically, there is a distance di between a center O_{C1} of the first winding column C1 and a center O_{C2} of the second winding column C2 in the length direction LD, and there is a distance d_{W} between the center O_{C1} of the first winding column C1 and the center O_{C2} of the second winding column C2 in the width direction WD. That is, the first winding column C1 and the second winding column C2 are diagonally arranged in the magnetic component 200, rendering the present invention different from the horizontal arrangement of the prior art. Therefore, in a situation with a preset cooling airflow direction along the length direction LD, the second winding W2, the first winding column C1 and the second winding column C2 of the magnetic component 200 can be all passed by airflow by this diagonal configuration, thereby solving the problem about the uneven internal heat dissipation.

Further, the lower cover body 212 has a base 212B and two side columns. The first winding column C1 and the second winding column C2 are formed on the base 212B. In this embodiment, the two side columns are a left column 212L and a right column 212R. The left column 212L and the right column 212R are formed at two ends of the base 212B. The first winding column C1 and the second winding column C2 are located between the left column 212L and the right column 212R. The first winding column C1 is adjacent to the left column 212L, and the second winding column C2 is adjacent to the right column 212R. Corresponding to the diagonal arrangement of the first winding column C1 and the second winding column C2 in the magnetic component 200, the left column 212L and the right column 212R are also deviated from each other along the width direction WD. As shown in FIG. 2A, in a height direction HD of the magnetic component 200, a height h_{212L} of the left column 212L is equal to a height h_{212R} of the right column 212R, and the heights of these two side columns are greater than a height h_{212B} of the base 212B. The height direction HD (parallel to Z-axis in drawings) is perpendicular to the length direction LD and the width direction WD.

As shown in FIG. 2B, a projection of the first winding column C1 in the length direction LD fully overlaps the left column 212L, and a projection of the second winding column C2 in the length direction LD fully overlaps the right column 212R. Further, the base 212B has two opposite oblique-lined side walls. In this embodiment, the two oblique-lined side walls are respectively the front oblique-lined side wall I1 and the rear oblique-lined side wall I2. The front oblique-lined side wall I1 and the rear oblique-lined side wall I2 are connected between the left column 212L and the right column 212R. The so-called “oblique-lined” side wall refers to a degree of inclination relative to the left column 212L and the right column 212R (wherein the side columns extend parallel to X-axis in drawings), rather than forming a right angle. The front oblique-lined side wall I1 and the rear oblique-lined side wall I2 are each a single side wall structure. This oblique-lined structure design is to correspond to the diagonal arrangement of the first winding column C1 and the second winding column C2 of the magnetic component 200, and it can reduce a floor space of the base 212B.

As shown in FIG. 2C, corresponding to the structure of the lower cover body 212, the upper cover body 211 also has the same designed base 211B, left column 211L and right column 211R. The left column 211L of the upper cover body 211 abuts against the left column 212L of the lower cover body 212, and the right column 211R of the upper cover body 211 abuts against the right column 212R of the lower cover body 212, so that the upper cover body 211 and the lower cover body 212 can be stacked. As shown in FIG. 2D, corresponding to the structure of the lower cover body 212, the upper cover body 211 also has a third winding column C3 and a fourth winding column C4. Similar to the design of the lower cover body 212, the third winding column C3 and the fourth winding column C4 are spaced apart along the length direction LD, and the third winding column C3 and the fourth winding column C4 are configured deviated from each other along the width direction WD. As such, the first winding column C1 of the lower cover body 212 can be aligned with the third winding column C3 of the upper cover body 211, and the second winding column C2 of the lower cover body 212 can be aligned with the fourth winding column C4 of the upper cover body 211. In this embodiment, when the upper cover body 211 and the lower cover body 212 are stacked, there is a gap d₁₃ between the first winding column C1 and the third winding column C3, and there is a gap d₂₄ between the second winding column C2 and the fourth winding column C4, but the present invention is not limited thereto. Alternatively, the first winding column C1 may also be in contact with the third winding column C3, and the second winding column C2 may also be in contact with the fourth winding column C4.

The third embodiment is described as follows:

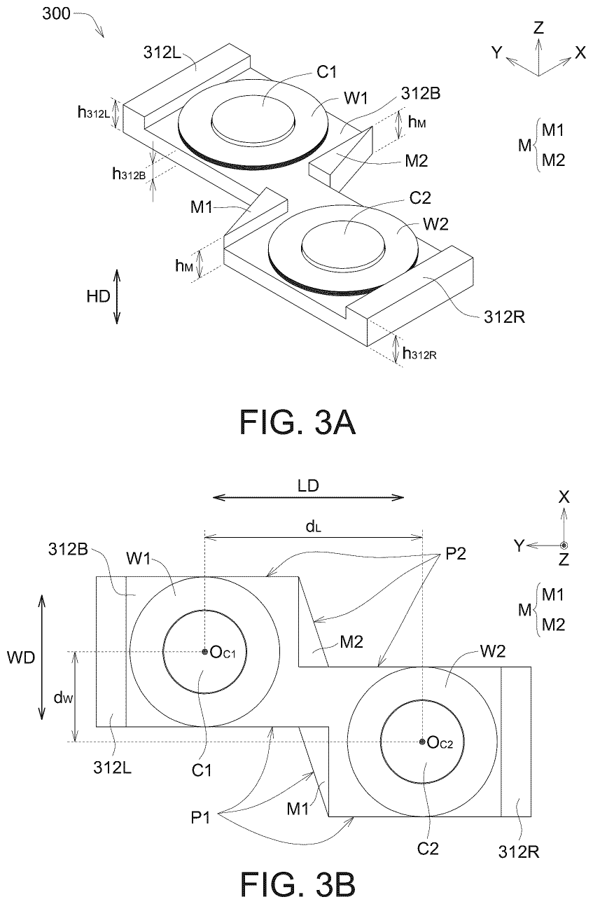

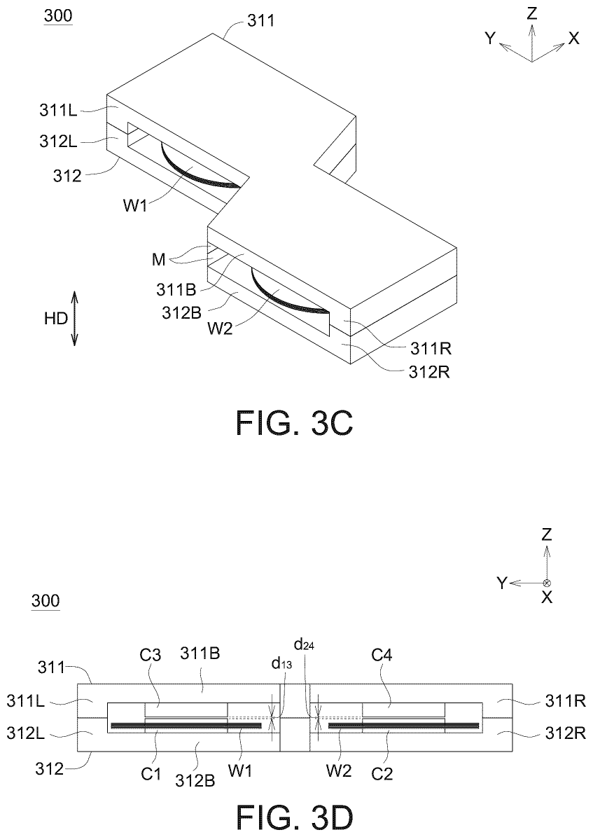

Please refer to FIG. 3A to FIG. 3D, which illustrate a magnetic component 300 of the first embodiment of the present invention. FIG. 3A and FIG. 3C show three dimensional views of the magnetic component 300. FIG. 3B shows a top view corresponding to FIG. 3A. FIG. 3D shows a top view corresponding to FIG. 3C. In order to clearly show an internal arrangement of the magnetic component 300, an upper cover body 311 of the magnetic core of the magnetic component 300 is not shown in FIG. 3A and FIG. 3B.

The magnetic component 300 of this embodiment is, for example, a transformer, a ferrite core inductor or a combination thereof. The magnetic component 300 comprises a magnetic core, a first winding W1 and a second winding W2. The magnetic core includes an upper cover body 311 and a lower cover body 312. The lower cover body 312 has a first winding column C1 and a second winding column C2. The first winding W1 is wound around the first winding column C1, and the second winding W2 is wound around the second winding column C2. The first winding W1 and the second winding W2 may respectively be a primary coil and a secondary coil. The number of the primary coil and the secondary coil depends on the actual application requirement, and the present invention is not limited thereto. The shape of the first winding column C1 and the second winding column C2 is, for example, cylinder, but the present invention is not limited thereto. The shape of the first winding column C1 and the second winding column C2 may both be prisms. Alternatively, the shape of the first winding column C1 and the second winding column C2 may also be different, for example, one is a cylinder, and the other is a prism.

As shown in FIG. 3B, the first winding column C1 and the second winding column C2 are spaced apart along a length direction LD of the magnetic component 300, and the first winding column C1 and the second winding column C2 are configured deviated from each other along a width direction WD of the magnetic component 300. The width direction WD (parallel to X-axis in drawings) is perpendicular to the length direction LD (parallel to Y-axis in drawings). Specifically, there is a distance di between a center O_{C1} of the first winding column C1 and a center O_{C2} of the second winding column C2 in the length direction LD, and there is a distance d_{W} between the center O_{C1} of the first winding column C1 and the center O_{C2} of the second winding column C2 in the width direction WD. That is, the first winding column C1 and the second winding column C2 are diagonally arranged in the magnetic component 300, rendering the present invention different from the horizontal arrangement of the prior art.

Further, the lower cover body 312 has a base 312B and two side columns. The first winding column C1 and the second winding column C2 are formed on the base 312B. In this embodiment, the two side columns are a left column 312L and a right column 312R. The left column 312L and the right column 312R are formed at two ends of the base 312B. The first winding column C1 and the second winding column C2 are located between the left column 312L and the right column 312R. The first winding column C1 is adjacent to the left column 312L, and the second winding column C2 is adjacent to the right column 312R. Corresponding to the diagonal arrangement of the first winding column C1 and the second winding column C2 in the magnetic component 300, the left column 312L and the right column 312R are also deviated from each other along the width direction WD.

The lower cover body 312 further has a middle column M. The middle column M is formed on the base 312B. The middle column M is located between the left column 312L and the right column 312R, and between the first winding column C1 and the second winding column C2. In this embodiment, the middle column M includes a first side column portion M1 and a second side column portion M2. There is a gap between the first side column portion M1 and the second side column portion M2. In other words, the middle column M is a mountain-like structure with a notch in its center, which extends along the width direction WD. By a design of gap between the first side column portion M1 and the second side column portion M2 (or called a design of notch in the center of the middle column M), in a situation with a preset cooling airflow direction along the length direction LD, the airflow can firstly pass one combination of a winding and a winding column, and then pass the other combination of a winding and a winding column via the gap (or notch), so that the first winding W1, the second winding W2, the first winding column C1 and the second winding column C2 of the magnetic component 300 can be passed by airflow, thereby solving the problem about the uneven internal heat dissipation. For example, the first side column portion M1 and/or the second side column portion M2 is/are a prism(s), but the present invention is not limited thereto, as long as the base 312B forms a protruding structure like the middle column M. As shown in FIG. 3A, in a height direction HD of the magnetic component 300, a height h_{312L} of the left column 312L is equal to a height h_{312R} of the right column 312R, and the heights of these two side columns are greater than a height h_{312B} of the base 312B. A height h_{M} of the middle column M is equal to the height h_{312L} of the left column 312L and the height h_{312R} of the right column 312R, but the present invention is not limited thereto. For example, in a scenario with a higher heat dissipation requirements, the height h_{M} of the middle column M may be lesser than the height h_{312L} of the left column 312L or the height h_{312R} of the right column 312R, so as to allow more airflow (along the length direction LD) to pass.

As shown in FIG. 3B, a projection of the first winding column C1 in the length direction LD fully overlaps the left column 312L, and a projection of the second winding column C2 in the length direction LD fully overlaps the right column 312R. Further, the base 312B has two opposite polyline side walls. In this embodiment, the two polyline side walls are respectively the front polyline side wall P1 and the rear polyline side wall P2. The front polyline side wall P1 and the rear polyline side wall P2 are connected between the left column 312L and the right column 312R. The front polyline side wall P1 and the rear polyline side wall P2 are each a polygonal wall structure. This polyline line structure design is to correspond to the diagonal arrangement of the first winding column C1 and the second winding column C2 of the magnetic component 300, and it can reduce a floor space of the base 312B. In this embodiment, the middle column M and the base 312B share a partial wall of the front polyline side wall P1 and the rear polyline side wall P2, which is a line segment in middle of the front polyline side wall P1 or the rear polyline side wall P2. In addition, by the design of the middle column M, the cross-sectional area of the magnetic flux passing through the center of the magnetic component 300 can be enhanced through the first side column portion M1 and the second side column portion M2, thereby reducing the magnetic flux density and the core loss of the magnetic core.

As shown in FIG. 3C, corresponding to the structure of the lower cover body 312, the upper cover body 311 also has the same designed base 311B, left column 311L and right column 311R. The left column 311L of the upper cover body 311 abuts against the left column 312L of the lower cover body 312, and the right column 311R of the upper cover body 311 abuts against the right column 312R of the lower cover body 312, so that the upper cover body 311 and the lower cover body 312 can be stacked. As shown in FIG. 3D, corresponding to the structure of the lower cover body 312, the upper cover body 311 also has a third winding column C3 and a fourth winding column C4. Similar to the design of the lower cover body 312, the third winding column C3 and the fourth winding column C4 are spaced apart along the length direction LD, and the third winding column C3 and the fourth winding column C4 are configured deviated from each other along the width direction WD. As such, the first winding column C1 of the lower cover body 312 can be aligned with the third winding column C3 of the upper cover body 311, and the second winding column C2 of the lower cover body 312 can be aligned with the fourth winding column C4 of the upper cover body 311. In this embodiment, when the upper cover body 311 and the lower cover body 312 are stacked, there is a gap d₁₃ between the first winding column C1 and the third winding column C3, and there is a gap d₂₄ between the second winding column C2 and the fourth winding column C4, but the present invention is not limited thereto. Alternatively, the first winding column C1 may also be in contact with the third winding column C3, and the second winding column C2 may also be in contact with the fourth winding column C4.

The fourth embodiment is described as follows:

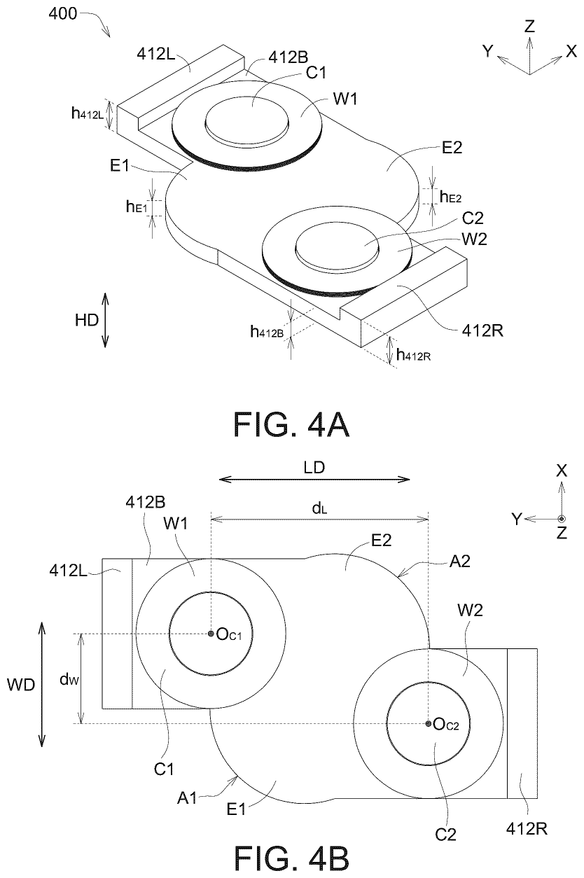

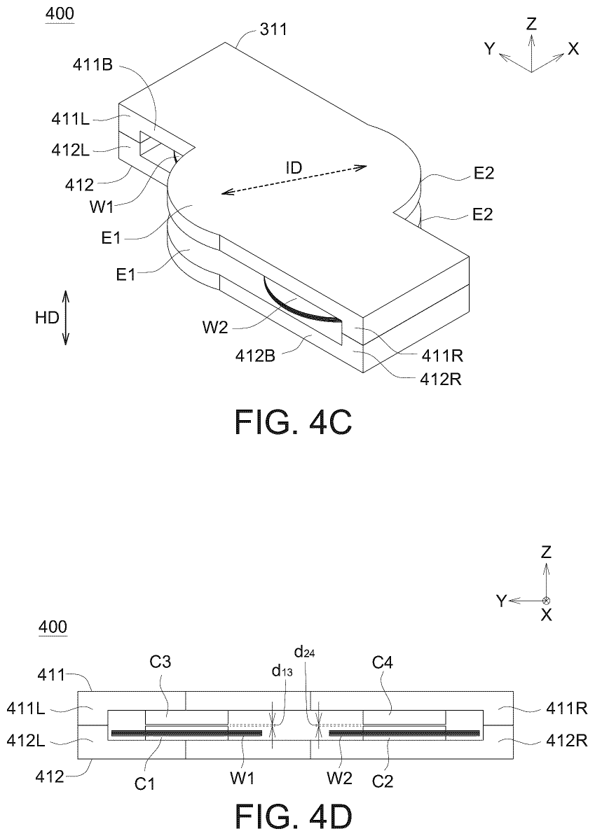

Please refer to FIG. 4A to FIG. 4D, which illustrate a magnetic component 400 of the first embodiment of the present invention. FIG. 4A and FIG. 4C show three dimensional views of the magnetic component 400. FIG. 4B shows a top view corresponding to FIG. 4A. FIG. 4D shows a top view corresponding to FIG. 4C. In order to clearly show an internal arrangement of the magnetic component 400, an upper cover body 411 of the magnetic core of the magnetic component 400 is not shown in FIG. 4A and FIG. 4B.

The magnetic component 400 of this embodiment is, for example, a transformer, a ferrite core inductor or a combination thereof. The magnetic component 400 comprises a magnetic core, a first winding W1 and a second winding W2. The magnetic core includes an upper cover body 411 and a lower cover body 412. The lower cover body 412 has a first winding column C1 and a second winding column C2. The first winding W1 is wound around the first winding column C1, and the second winding W2 is wound around the second winding column C2. The first winding W1 and the second winding W2 may respectively be a primary coil and a secondary coil. The number of the primary coil and the secondary coil depends on the actual application requirement, and the present invention is not limited thereto. The shape of the first winding column C1 and the second winding column C2 is, for example, cylinder, but the present invention is not limited thereto. The shape of the first winding column C1 and the second winding column C2 may both be prisms. Alternatively, the shape of the first winding column C1 and the second winding column C2 may also be different, for example, one is a cylinder, and the other is a prism.

As shown in FIG. 4B, the first winding column C1 and the second winding column C2 are spaced apart along a length direction LD of the magnetic component 400, and the first winding column C1 and the second winding column C2 are configured deviated from each other along a width direction WD of the magnetic component 400. The width direction WD (parallel to X-axis in drawings) is perpendicular to the length direction LD (parallel to Y-axis in drawings). Specifically, there is a distance di between a center O_{C1} of the first winding column C1 and a center O_{C2} of the second winding column C2 in the length direction LD, and there is a distance d_{W} between the center O_{C1} of the first winding column C1 and the center O_{C2} of the second winding column C2 in the width direction WD. That is, the first winding column C1 and the second winding column C2 are diagonally arranged in the magnetic component 400, rendering the present invention different from the horizontal arrangement of the prior art. Therefore, in a situation with a preset cooling airflow direction along the length direction LD, the second winding W2, the first winding column C1 and the second winding column C2 of the magnetic component 400 can be all passed by airflow by this diagonal configuration, thereby solving the problem about the uneven internal heat dissipation.

Further, the lower cover body 412 has a base 412B and two side columns. The first winding column C1 and the second winding column C2 are formed on the base 412B. In this embodiment, the two side columns are a left column 412L and a right column 412R. The left column 412L and the right column 412R are formed at two ends of the base 412B. The first winding column C1 and the second winding column C2 are located between the left column 412L and the right column 412R. The first winding column C1 is adjacent to the left column 412L, and the second winding column C2 is adjacent to the right column 412R. Corresponding to the diagonal arrangement of the first winding column C1 and the second winding column C2 in the magnetic component 400, the left column 412L and the right column 412R are also deviated from each other along the width direction WD. As shown in FIG. 4B, a projection of the first winding column C1 in the length direction LD fully overlaps the left column 412L, and a projection of the second winding column C2 in the length direction LD fully overlaps the right column 412R.

The lower cover body 412 further has two outward expansion structures. In this embodiment, the two outward expansion structures are the front outward expansion structure E1 and the rear outward expansion structure E2. The front outward expansion structure E1 and the rear outward expansion structure E2 are convexly formed on the base 412B along an inclined direction ID. The inclined direction ID is oblique to the length direction LD and the width direction WD (that is, parallel to an inclined line on X-Y plane in drawings). As shown in FIG. 4B, the front outward expansion structure E1 has an arc-lined side wall A1, and the rear outward expansion structure E2 has an arc-lined side wall A2, but the present invention is not limited thereto. Side wall shapes of the front outward expansion structure E1 and the rear outward expansion structure E2 may also be different and are not only limited to arc-lined side walls. For example, the front outward expansion structure E1 may have a polygonal wall structure, and the rear outward expansion structure E2 may have the arc-lined side wall A2. Alternatively, the front outward expansion structure E1 may have the arc-lined side wall A1, and the rear outward expansion structure E2 may have a polygonal wall structure.

As shown in FIG. 4A, in a height direction HD of the magnetic component 400, a height h_{412L} of the left column 412L is equal to a height h_{412R} of the right column 412R, and the heights of these two side columns are greater than a height h_{412B} of the base 412B. A height he of the front outward expansion structure E1 and a height h_{E2} of the rear outward expansion structure E2 are equal to the height h_{412B} of the base 412B. That is, the height h_{E1} of the front outward expansion structure E1 and the height h_{E2} of the rear outward expansion structure E2 are lesser than the height h_{412L} of the left column 412L and the height h_{412R} of the right column 412R. The height direction HD (parallel to Z-axis in drawings) is perpendicular to the length direction LD and the width direction WD. By the design of outward expansion structure, the cross-sectional area of the magnetic flux passing through the center of the magnetic component 400 can be enhanced through the front outward expansion structure E1 and the rear outward expansion structure E2, thereby reducing the magnetic flux density and the core loss of the magnetic core.

As shown in FIG. 4C, corresponding to the structure of the lower cover body 412, the upper cover body 411 also has the same designed base 411B, left column 411L and right column 411R. The front outward expansion structure E1 and the rear outward expansion structure E2 are also formed on the base 411B. The left column 411L of the upper cover body 411 abuts against the left column 412L of the lower cover body 412, and the right column 411R of the upper cover body 411 abuts against the right column 412R of the lower cover body 412, so that the upper cover body 411 and the lower cover body 412 can be stacked. When the upper cover body 411 and the lower cover body 412 are stacked, The front outward expansion structure E1 of the upper cover body 411 and the front outward expansion structure E1 of the lower cover body 412 can be longitudinally aligned, and the rear outward expansion structure E2 of the upper cover body 411 and the rear outward expansion structure E2 of the lower cover body 412 can be longitudinally aligned.

As shown in FIG. 4D, corresponding to the structure of the lower cover body 412, the upper cover body 411 also has a third winding column C3 and a fourth winding column C4. Similar to the design of the lower cover body 412, the third winding column C3 and the fourth winding column C4 are spaced apart along the length direction LD, and the third winding column C3 and the fourth winding column C4 are configured deviated from each other along the width direction WD. As such, the first winding column C1 of the lower cover body 412 can be aligned with the third winding column C3 of the upper cover body 411, and the second winding column C2 of the lower cover body 412 can be aligned with the fourth winding column C4 of the upper cover body 411. In this embodiment, when the upper cover body 411 and the lower cover body 412 are stacked, there is a gap d₁₃ between the first winding column C1 and the third winding column C3, and there is a gap d₂₄ between the second winding column C2 and the fourth winding column C4, but the present invention is not limited thereto. Alternatively, the first winding column C1 may also be in contact with the third winding column C3, and the second winding column C2 may also be in contact with the fourth winding column C4.

It should be noted that the lower cover body described in the above-mentioned embodiments of the present invention is not limited to be assembled with the upper cover body described in the same embodiment. By the size and alignment of the left and right columns of the upper cover body being complied with the left and right columns of the lower cover body, the upper cover body and the lower cover body of each embodiment can be flexibly assembled.

According to the description above, it can be known that the magnetic components of the above embodiments use a combination of the first winding and the first winding column and a combination of the second winding and the second winding column in the magnetic core to be a deviation configuration, so that in a situation with a preset cooling airflow direction, the combination of each winding and each winding column in the magnetic component can be passed by the airflow, thereby solving the problem about the uneven internal heat dissipation. In detail, as the degree of deviation between the first winding column C1 and the second winding column C2 in the embodiment becomes higher, namely the value of the distance d_{W} is higher, the winding farther away from the airflow supplier can be passed by more airflow, thereby bringing a better overall heat dissipation effect to the magnetic component.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A magnetic component, comprising:
a magnetic core, including an upper cover body and a lower cover body, wherein the upper cover body and the lower cover body are stacked, and the lower cover body has a first winding column and a second winding column;
a first winding, wound on the first winding column; and
a second winding, wound on the second winding column;
wherein the first winding column and the second winding column are spaced apart along a length direction of the magnetic component; the first winding column and the second winding column are configured deviated from each other along a width direction of the magnetic component; the width direction is perpendicular to the length direction.

2. The magnetic component of claim 1, wherein the lower cover body has a base and two side columns; the two side columns are formed at two ends of the base; the first winding column and the second winding column are formed on the base and located between the two side columns.

3. The magnetic component of claim 2, wherein the two side columns are deviated from each other along the width direction.

4. The magnetic component of claim 2, wherein the first winding column is adjacent to one of the two side columns and a projection of which in the length direction fully overlaps the one of the two side columns; the second winding column is adjacent to the other of the two side columns and a projection of which in the length direction fully overlaps the other of the two side columns.

5. The magnetic component of claim 2, wherein the base has two polyline side walls opposite to each other; the two polyline side walls are connected between the two side columns.

6. The magnetic component of claim 2, wherein the base has two oblique-lined side walls opposite to each other; the two oblique-lined side walls are connected between the two side columns.

7. The magnetic component of claim 2, wherein the upper cover body has a middle column; the middle column is formed on the base and located between the first winding column and the second winding column.

8. The magnetic component of claim 7, wherein in a height direction of the magnetic component perpendicular to the length direction and the width direction, a height of the middle column is equal to a height of the two side columns.

9. The magnetic component of claim 7, wherein the middle column includes a first side column portion and a second side column portion; there is a distance between the first side column portion and the second side column portion.

10. The magnetic component of claim 9, wherein a projection of the first winding column in the length direction at least partially overlaps the first side column portion; a projection of the second winding column in the length direction at least partially overlaps the second side column portion.

11. The magnetic component of claim 9, wherein the first side column portion and/or the second side column portion is/are a prism(s).

12. The magnetic component of claim 2, wherein the lower cover body has two outward expansion structures; the two outward expansion structures protrude from the base along an inclined direction; the inclined direction is inclined to the length direction and the width direction.

13. The magnetic component of claim 12, wherein at least one of the two outward expansion structures has an arc-lined side wall.

14. The magnetic component of claim 12, wherein in a height direction of the magnetic component perpendicular to the length direction and the width direction, a height of the two outward expansion structures is lesser than a height of the two side columns.

15. The magnetic component of claim 1, wherein the first winding column and/or the second winding column is/are a cylinder(s).

16. The magnetic component of claim 1, wherein the upper cover body has a third winding column and a fourth winding column; the third winding column and the fourth winding column are spaced apart along the length direction; the third winding column and the fourth winding column are configured deviated from each other along the width direction; the first winding column is aligned with the third winding column; the second winding column is aligned with the fourth winding column.

17. The magnetic component of claim 16, wherein there is a gap between the first winding column and the third winding column.

18. The magnetic component of claim 16, wherein the first winding column abuts against the third winding column.

19. The magnetic component of claim 16, wherein there is a gap between the second winding column and the fourth winding column.

20. The magnetic component of claim 16, wherein the second winding column abuts against the fourth winding column.
